(19) United States
(12) Patent Application Publication
(10) Pub. No.: US 2021/0039310 A1
(43) Pub. Date: Feb. 11, 2021

(54) SLM SYSTEM AND METHOD FOR OPERATING THE SLM SYSTEM

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/964,242

(22) PCT Filed: Jan. 22, 2019
(86) PCT No.: PCT/EP2019/051486

§ 371 Date: Jul. 23, 2020

(30) Foreign Application Priority Data
Feb. 21, 2018 (DE) 10 2018 202 600.9

(51) Int. Cl. B29C 64/153; B29C 64/268; B29C 64/386; B23K 26/082; B29C 64/286

(52) U.S. Cl. CPC B29C 64/153; B29C 64/268; B33Y 10/00; B23K 26/082; B29C 64/286; B29C 64/386

(57) ABSTRACT

A method for operating an SLM system, includes the following steps: a) providing a construction space in the SLM system, which construction space includes a component and, adjacent thereto, a powder, a surface of the construction space that faces upward having regions that are formed by the component and other regions that are formed by the powder; b) scanning the surface that faces upward with laser radiation, the power and duration of action of which are selected in such a way that the component and the powder are not melted; c) detecting radiation that results from interaction of the laser radiation with the construction space; d) inferring a position and dimensions of the component from the radiation detected in step c).

### CROSS REFERENCE TO RELATED APPLICATIONS

This application is the US National Stage of International Application No. PCT/EP2019/051486 filed 22 Jan. 2019, and claims the benefit thereof. The International Application claims the benefit of German Application No. DE 10 2018 202 600.9 filed 21 Feb. 2018. All of the applications are incorporated by reference herein in their entirety.

### FIELD OF INVENTION

The invention relates to an SLM system and method for operating the SLM system.

### BACKGROUND OF INVENTION

An SLM system is a system in which a component is constructed layer-by-layer by means of selective laser melting (SLM) of a powder. For large components, a so-called hybrid selective laser melting can be used. In doing so, first one portion of the component is produced by means of another production method, such as for example by means of casting. Subsequently, said one portion is introduced into the SLM system and another portion of the component is applied onto said one portion by means of the selective laser melting. In order that said one portion and the other portion fit on top of one another as exactly as possible, it would be desirable to determine as exactly as possible where said one portion is located in the SLM system.

### SUMMARY OF INVENTION

The object of the invention is thus to provide an SLM system and a method for operating the SLM system, with which a location of a component in the SLM system is determinable with a highest possible accuracy.

The method according to the invention for operating an SLM system has the steps: a) providing a construction space in the SLM system, which construction space comprises a component and a powder adjacent thereto, wherein an upward facing surface of the construction space has regions that are formed by the component and other regions that are formed by the powder; b) scanning the upward facing surface with laser radiation, the power and duration of action of which are selected in such a way that the component and the powder are not melted; c) detecting radiation that results from interaction of the laser radiation with the construction space; d) inferring a position and dimensions of the component from the radiation detected in step c).

With the method according to the invention it is possible to determine the position and the dimensions of the component with a particularly high accuracy. Moreover, in step b) the same laser source can be used as in a subsequent selective laser melting, such that a conventional SLM system is cost-effectively upgradable for carrying out the method according to the invention.

The level of power and the duration of action of the laser radiation to be selected depend on many properties of the component and of the powder, such as, for example, on surface characteristics, on an absorptivity for the laser radiation, on a thermal conductivity, on a particle size distribution and a packing density of the powder. These properties can vary very strongly for different materials. However, it is possible, without problems or great effort, to carry out experiments in which the power of the laser radiation and/or the duration of action of the laser radiation are varied for such a time that neither the component nor the powder are melted and simultaneously in step c) sufficient of the radiation is detected that the position and the dimensions of the component are determinable.

The interaction may be, for example, a reflection and/or a scattering at the upward facing surface of the construction space. This means that, in step c), laser radiation reflected and/or scattered by the upward facing surface of the construction space is measured. The interaction may also be, for example, a heating of the construction space, which means that the laser radiation is at least partially absorbed by the construction space and, in step c), thermal radiation emitted by the construction space is measured.

It is advantageous that the method has the step: e) identifying, on the basis of the dimensions, the area of the component arranged in the upward facing surface of the construction space in a three-dimensional computer model which includes the component. Moreover, the method has the step: f) applying at least one layer of the powder to the upward facing surface of the construction space and extending the component by means of selective laser melting of the powder using laser radiation in each of the layers on the basis of the position and the area identified in the three-dimensional computer model. In step a), one portion of the component is provided and, in step f), another portion of the component is completed by means of the selective laser melting. By means of the method steps e) and f), it is advantageously achieved that exactly that part of the computer model which is not formed by said one portion is produced in step f), and thus the said one portion and the other portion fit on top of one another particularly well. For example, in such a way, manufacturing tolerances in the production of said one portion can be compensated for. Moreover, it is possible to produce the component to be free of edges and/or ridges.

It is advantageous that the same laser source is used for generating the laser radiation in steps b) and f). On account thereof, an identical or at least very similar grid is used when inferring the position and the dimensions of the component and during the selective laser melting, such that said one portion and the other portion fit on top of one another particularly well in the component.

It is advantageous that the radiation is thermal radiation. Thermal radiation has the advantage that it is emitted uniformly in all directions, and so there is much flexibility regarding where a detector for detecting the thermal radiation can be arranged in the SLM system. The thermal radiation is advantageously detected at a detection wavelength which is different from the wavelength of the laser radiation. On account thereof, it can be advantageously avoided that the laser radiation is detected in step c), which can falsify inferring the position and the dimensions of the component in step d).

In step c), advantageously that part of the radiation which, emanating from a point of incidence of the laser radiation arranged on the upward facing surface of the construction space, propagates counter to the direction of the laser radiation is detected. Advantageously, it is a construction that is simple to adjust. For example, the radiation can be separated from the laser radiation using a beam splitter.

Alternatively, it is advantageous that in step c), that part of the radiation is detected which, emanating from a point of incidence of the laser radiation arranged on the upward facing surface of the construction space, propagates offset to the direction of the laser radiation. On account thereof, the amount of the laser radiation which is detected together with the radiation in step c) and which can falsify the inferring of the position and the dimensions of the component in step d) is advantageously reduced.

It is advantageous that, in step d), a grid of intensities of the radiation detected in step c) is formed and transitions from the regions to the other regions are determined by means of identifying gradients of the intensities in the grid. In dependence on the properties of the component and of the powder and in dependence on how the radiation is constituted and how it is detected, the transition from the regions that are formed by the component to the other regions that are formed by the powder can be accompanied by a reduction of the detected intensity or an increase of the detected intensity. In doing so it is advantageous that, in step c), first the grid is scanned with a coarse mesh and, after determining the transitions in step d), the grid is scanned with a fine mesh in the region of the transitions. On account thereof, the position and the dimensions of the component can be inferred with a particularly high accuracy in a simultaneous short time period.

The regions and the other regions advantageously lie in a same horizontal plane, in particular the regions and the other regions lie completely in a same horizontal plane.

The SLM system according to the invention is configured to carry out the steps of the method according to the invention or according to a method.

### BRIEF DESCRIPTION OF THE DRAWINGS

In the following, the invention is explained in further detail with the aid of the attached schematic drawings.

FIG. 1 shows a cross-section through an SLM system,

FIG. 2 shows a component and

FIG. 3 shows the component with a grid.

### DETAILED DESCRIPTION OF INVENTION

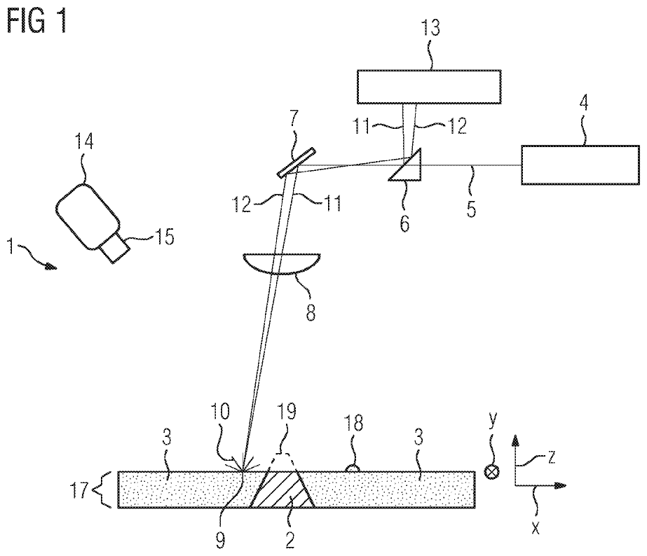

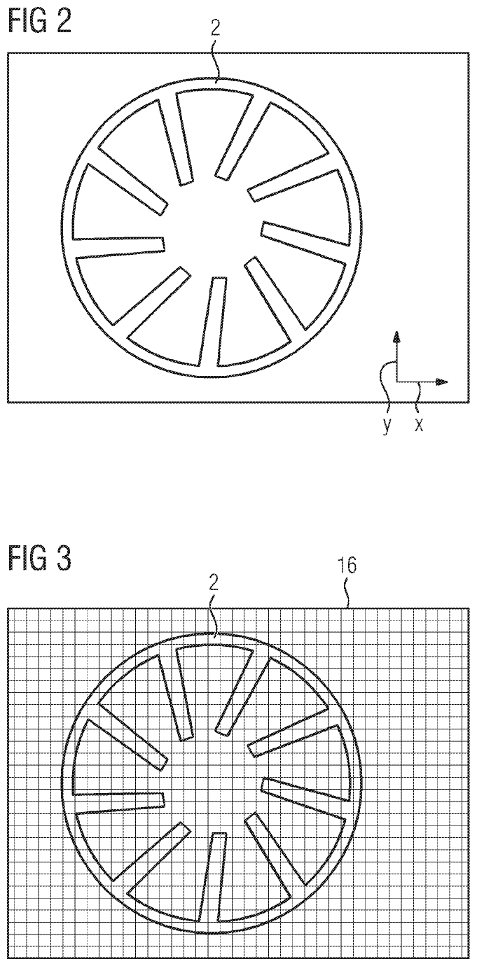

As can be seen in FIG. 1, a construction space 17 was provided in an SLM system 1 in step a). The construction space 17 has a component 2 and a powder 3 adjacent thereto. An upward facing surface 18 of the construction space 17 has regions that are formed by the component 2 and other regions that are formed by the powder 3. The regions and the other regions lie completely in a same horizontal plane. The component 2 can be produced by means of a production method which is different from a generative production method, in particular selective laser melting, for example by means of casting. The powder 3 may be, for example, a metal powder and/or a ceramic powder.

The SLM system 1 moreover has a laser source 4, which is configured to emit laser radiation. The laser source 4 can be, for example, an Nd:YAG laser. In this case, the laser radiation may be formed by the fundamental wavelength of the Nd:YAG laser and thus have a wavelength of 1064 nm. In operation of the SLM system 1, the laser radiation propagates along a beam path 5. The SLM system 1 has a beam splitter 6, a scan mirror 7 and a lens system 8. As can be seen in FIG. 1, the SLM system 1 is configured to direct the laser radiation to the scan mirror 7 by way of the beam splitter 6. The scan mirror 7 is movably mounted and actuatable by the SLM system 1 in such a way that the laser radiation can be directed to each desired point of the upward facing surface 18 of the construction space 17 by way of the lens system 8, which is arranged in the beam path 5 between the scan mirror 7 and the upward facing surface 18 of the construction space 17. The lens system 8 is configured to focus the laser radiation onto the upward facing surface 18 of the construction space 17. The lens system 8 is, for example, an F-Theta objective.

In a step b), the upward facing surface 18 is scanned with the laser radiation, wherein the power and the duration of action of the laser radiation are selected in such a way that the component 2 and the powder 3 are not melted. Moreover, the power and the duration of action of the laser radiation are selected in such a way that the component 2 and the powder 3 are heated. In the case that the laser source 4 is an Nd:YAG laser, the power can be varied by varying the light power with which an Nd:YAG crystal of the Nd:YAG laser is pumped. On the basis of an interaction of the laser radiation with the construction space 17 at a point of incidence 9 of the laser radiation, which is arranged on the upward facing surface 18 of the construction space, thermal radiation 10 is emitted.

In a step c), the thermal radiation is detected. In doing so, the thermal radiation can be detected at a detection wavelength which is different from the wavelength of the laser radiation. In the Nd:YAG laser, the detection wavelength may be, for example, longer than 1064 nm. This can take place, for example, by means of a detector 13 or by means of a camera 14. It is sufficient if the detector 13 has only one single detector element, such as, for example, a photodiode. Conversely, the camera 14 further has a two-dimensional matrix of detector elements. The camera 14 may be, for example, a CMOS camera or a microbolometer camera. The camera 14 has an objective 15, which is configured to image the upward facing surface 18 of the construction space 17 onto the two-dimensional matrix of the detector elements. On account of the scan mirror 7 and the lens system 8, it is difficult to align the camera 14 perpendicular to the upward facing surface 18 of the construction space 17. The imaging aberrations, which occur on account of an oblique orientation of the camera 14 to the upward facing surface 18 of the construction space 17, can be corrected, for example by a Scheimpflug objective being used for the objective 15.

FIG. 1 shows that the detector 13 is arranged to detect the thermal radiation reflected at the beam splitter 6. It is likewise conceivable that the detector 13 is arranged at another position in the SLM system, so long as the field of view of the detector 13 includes the complete upward facing surface 18 of the construction space 17. The thermal radiation reflected by the beam splitter 6 that is to be detected has the advantage that the lens system 8 collects, and guides onto the detector 13, a larger amount of the infrared radiation than if the detector 13 is arranged at the other position. FIG. 1 shows a first beam path 11 of the thermal radiation 10, which describes that part of the thermal radiation which, emanating from the point of incidence 9 of the laser radiation, propagates counter to the direction of the laser radiation. Also drawn is a second beam path 12 of the thermal radiation 10, which describes that part of the thermal radiation which, emanating from the point of incidence 9 of the laser radiation, propagates offset to the direction of the laser radiation. It is conceivable here that, in step c), the thermal radiation is detected from only the first beam path 11, from only the second beam path 12 or from both beam paths 11 and 12. The first beam path 11 may also have the laser radiation. For example, the laser radiation in the first beam path 11 may have been reflected back from the lens system 8 and been incompletely separated from the thermal radiation 10 at the beam splitter 6. This incompletely separated laser radiation can disrupt the detection of the thermal radiation. Here, it can be advantageous to detect only the thermal radiation in the second beam path 12.

In a step d), a position and dimensions of the component 2 are inferred from the thermal radiation detected in step c). For this purpose, a grid 16 of intensities of the radiation detected in step c) is formed and transitions from the regions to the other regions are determined by means of identifying gradients of the intensities in the grid 16. As can be seen in FIGS. 1 and 3, the grid 16 spans in the x direction and in the y direction. For comparison, the x direction, the y direction and additionally also a z direction are likewise drawn in FIG. 1. It is conceivable that, in step c), first the grid 16 is scanned with a coarse mesh and, after determining the transitions in step d), the grid 16 is scanned with a fine mesh in the region of the transitions.

In a step e), on the basis of the dimensions, the area of the component 2 arranged in the upward facing surface 18 of the construction space 17 is identified in a three-dimensional computer model 19 which includes the component 2. The computer model 19 is shown in FIG. 1 and comprises a portion of the component 2, drawn in dashes, which is said one portion of the component 2, and a portion of the component 2, drawn with crosshatching, which is the other portion of the component 2. In a step f), at least one layer of the powder 3 is applied to the upward facing surface 18 of the construction space 17 and the component 2 is extended by means of selective laser melting of the powder 3 using laser radiation in each of the layers on the basis of the position and the area identified in the three-dimensional computer model 19. This is particularly relevant if the cross-section of the component 2, as illustrated in FIG. 1, varies in the z direction. The same laser source 4 can be used for generating the laser radiation in steps b) and f), as illustrated in FIG. 1.

Although the invention has been illustrated and described in greater detail by means of the exemplary embodiment, the invention is not restricted by the disclosed examples and other variations can be deduced from it by a person skilled in the art, without leaving the scope of the invention.

1. A method for operating an SLM system, comprising:
a) providing a construction space in the SLM system, wherein the construction space comprises a component and a powder adjacent thereto, wherein an upward facing surface of the construction space has regions that are formed by the component and other regions that are formed by the powder;
b) scanning the upward facing surface with laser radiation, wherein a power and a duration of action of the laser radiation are selected in such a way that the component and the powder are not melted;
c) detecting radiation that results from interaction of the laser radiation with the construction space, wherein the radiation is thermal radiation; and
d) inferring a position and dimensions of the component from the radiation detected in step c).

2. The method as claimed in claim 1, further comprising:
e) identifying, on the basis of the dimensions, an area of the component arranged in the upward facing surface of the construction space in a three-dimensional computer model which includes the component.

3. The method as claimed in claim 2, further comprising:
f) applying at least one layer of the powder to the upward facing surface of the construction space and extending the component by means of selective laser melting of the powder using laser radiation in each of the layers on the basis of the position and the area identified in the three-dimensional computer model.

4. The method as claimed in claim 3,
wherein the same laser source is used for generating the laser radiation in step b) and step f).

5. The method as claimed claim 1,
wherein the thermal radiation is detected at a detection wavelength which is different from the wavelength of the laser radiation.

6. The method as claimed in claim 1,
wherein in step c), that part of the radiation which, emanating from a point of incidence of the laser radiation arranged on the upward facing surface of the construction space, propagates counter to the direction of the laser radiation is detected.

7. The method as claimed in claim 1,
wherein in step c), that part of the radiation which, emanating from a point of incidence of the laser radiation arranged on the upward facing surface of the construction space, propagates offset to the direction of the laser radiation is detected.

8. The method as claimed in claim 1,
wherein, in step d), a grid of intensities of the radiation detected in step c) is formed and transitions from the regions to the other regions are determined by means of identifying gradients of the intensities in the grid.

9. The method as claimed in claim 8,
wherein, in step c), first the grid is scanned with a coarse mesh and, after determining the transitions in step d), the grid is scanned with a fine mesh in the region of the transitions.

10. The method as claimed in claim 1,
wherein the regions and the other regions lie in a same horizontal plane.

11. An SLM system, comprising:
a construction space and a laser source;
wherein the system is configured to carry out the steps of the method as claimed in claim 1.

12. The method as claimed in claim 10.
wherein the regions and the other regions lie completely in the same horizontal plane.
